(19) United States
(12) Patent Application Publication
(10) Pub. No.: US 2012/0201030 A1
(43) Pub. Date: Aug. 9, 2012

(54) PHOTOLUMINESCENCE COLOR WHEELS

(75) Inventors: Xianglong Yuan, Fremont, CA (US); Bing Dai, Fremont, CA (US); Tsun Yin Lau, Fremont, CA (US); Ian Collier, Hayward, CA (US)

(73) Assignee: INTEMATIX CORPORATION, Fremont, CA (US)

(21) Appl. No.: 13/367,325

(22) Filed: Feb. 6, 2012

Related U.S. Application Data
(60) Provisional application No. 61/440,233, filed on Feb. 7, 2011.

(51) Int. Cl. F21V 9/00; G02B 5/22

(52) U.S. Cl. 362/293; 359/892

(57) ABSTRACT

A color wheel comprises: a rotatable disc having a light reflective face and a region of photoluminescence material deposited on the light reflective face. The region of photoluminescence material comprises a substantially uniform thickness layer of a mixture of particles of the photoluminescence material that is deposited on the light reflective face of the disc by screen printing. The photoluminescence materials can comprise blue light or UV excitable photoluminescence materials such as phosphor materials or quantum dots. Color modulated light sources and a method of manufacturing a color wheel are also disclosed.

### CROSS-REFERENCE TO RELATED APPLICATION

This application claims the benefit of priority to U.S. Provisional Application No. 61/440,233, filed Feb. 7, 2011, entitled “Digital Projection Systems” the specification and drawings of which are incorporated herein by reference in their entirety.

### BACKGROUND OF THE INVENTION

1. Field of the Invention

This invention relates to color wheels that incorporate photoluminescence materials, such as color wheels that are used to implement digital projection systems or entertainment lighting.

2. Description of the Related Art

There are many types of light generating systems that can be used to implement digital projection and other forms of entertainment lighting products. For example, in a DLP™ (Digital Light Processing—DLP is a trademark of Texas Instruments) digital projection system, color images are generated using a semiconductor chip having an array of microscopic mirrors known as a Digital Micro-mirror Device (DMD) in which each mirror corresponds to one or more pixels of the image. In single-chip DLP projection systems color is produced by either using individual light sources to sequentially generate each of the primary colors (red, green and blue) or using a color wheel positioned between the DMD chip and a white light source. DLP projection systems are used in DLP front projectors for projecting presentations at meetings or conferences, projecting digital movies at movie theaters and in home cinemas and are used in DLP rear projection televisions.

FIG. 1 is a schematic of a single-chip DLP projection system 10 for projecting a color image 12 onto an image plane 14 (typically a screen). The projection system could comprise a part of a DLP front projector or a part of a DLP rear projection television and comprises a color modulated light source 16, optics 18, a DMD 20 and projection optics 22. In a color wheel system the modulated light source 16 comprises a white light source 24, typically a mercury-vapor metal halide high intensity arc lamp, optics 26 and a color wheel 28 for modulating the color of light generated by the lamp 24. As is known a color wheel 28 comprises a rotatable disc that is divided into a number of different light transmissive color filter elements 30 (Red), 30 (Green), 30 (Blue) in which each sector corresponds to a respective one of the primary colors red, green and blue. In operation the color wheel 28 is rotated at a constant rate and white light 32 generated by the lamp 24 is directed by the optics 26 onto a portion of the disc containing the filter elements 30. White light 32 that passes through the color wheel is filtered by the filter elements to generate color modulated light 34 comprising a repeating sequence of red, green and blue light in which the repetition rate is dependent on the speed of rotation of the color wheel. The modulated light 34 is directed by the optics 18 onto the DMD 20 whose operation is synchronized with the color wheel to selectively direct light of a selected color towards the projection optics 22 and thereby project a color image 12 onto the image plane 14.

A problem with DLP projection systems that use a color wheel can be the high intensity lamp 24 which can be easily damaged by vibration, needs cooling, has a relatively short operating light expectancy (approximately 4000 to 6000 hours) and is expensive (typically US$200 or more) to replace.

U.S. Pat. No. 7,547,114, to Yi-Qun L I et al., disclose a multicolor illumination device comprising an excitation light source such as an LED (Light Emitting Diode) or laser diode that is operable to generate excitation light in the UV or blue region and a transparent color wheel comprising sectors of different wavelength conversion materials (phosphors). A dichroic filter can be provided on the wheel to block excitation light contributing to the light output.

The present invention provides a color wheel that at least in part overcomes the limitations of the known devices.

### SUMMARY OF THE INVENTION

Embodiments of the invention concern photoluminescence color wheels that are used with solid-state light sources such as laser diodes or LEDs and can be used for example as part of a modulated color light source for digital projection systems or as a light source in entertainment lighting. A light reflective wheel comprising one or more regions (for example annular sectors or circular sectors) of different, photoluminescence, phosphor materials is used to convert (through a process of photoluminescence) the wavelength of the excitation light (typically blue or ultraviolet (UV) excitation light) generated by the solid-state light source into light of a desired color. In a digital projection system the color wheel can be configured to generate a time multiplexed sequence of primary colors typically red, green and blue.

In some embodiments the solid-state light source is operable to generate blue excitation light and the color wheel comprises sectors of blue light excitable photoluminescence materials that are operable to generate the other primary light colors red and green. The photoluminescence materials, which are typically in powder form, can be mixed with a light transmissive binder such as a liquid acrylic or silicone and the slurry deposited on the light reflective surface of the disc preferably by a printing process in particular screen printing. Preferably the sectors of different photoluminescence materials are deposited on the disc as one or more layers of uniform thickness. For sources that are intended to generate a color modulated output and are based on blue light generating solid-state sources, the portions of the wheel intended to generate blue light do not include a photoluminescence material and in one arrangement such portion(s) comprise an aperture, or through hole, to allow the periodic passage of light through the wheel. In other arrangements portions of the wheel intended to generate blue light can comprise a light reflective portion having a layer of a powdered light scattering material such as TiO₂ (titanium dioxide), barium sulfate (BaSO₄), magnesium oxide (MgO), silicon dioxide (SiO₂) or aluminum oxide (Al₂O₃) deposited on its surface. Preferably the light reflective material has light scattering/reflective properties that are similar to those of the light emitting properties of the photoluminescence materials.

Since a portion of the excitation light may be scattered by the photoluminescence material without being converted into photoluminescence light, the light source preferably comprises a wavelength selective optic, typically a dichroic element, which is configured to prevent such excitation light reaching the emission product of the source.

According to some embodiments of the invention a color wheel comprises a rotatable disc having a light reflective face and a region of photoluminescence material deposited on the light reflective face. In some embodiments the region of photoluminescence material is deposited on the light reflective face of the disc by screen printing a mixture of the phosphor material particles and a light transmissive binder. To optimize light generation the quantity of photoluminescence material per unit area is can be in a range 10 mg·cm⁻² to 50 mg·cm⁻² and may typically be in a range 30 mg·cm⁻² to 35 mg·cm⁻².

Typically the phosphor material regions comprise non-overlapping annular sectors or circular sectors comprising a uniform thickness layer of the phosphor/binder mixture. The light transmissive binder can comprise a curable liquid polymer such as a polymer resin, a monomer resin, an acrylic, an epoxy, a silicone or a fluorinated polymer. The thickness of the phosphor material regions are preferably in a range 40 μm to 120 μm and more preferably in a range 60 μm to 80 μm.

The photoluminescence material can comprise inorganic or organic materials including quantum dots, phosphor materials, a silicate-based phosphor material, a nitride-based phosphor material, a sulfate-based phosphor material, an oxy-nitride-based phosphor material, an oxy-sulfate-based phosphor material, a garnet structured phosphor material, a YAG-based (Yttrium Aluminum Garnet) phosphor material or combinations thereof. Alternatively the photoluminescence material can comprise a quantum dot. The photoluminescence materials can comprise materials that are excitable by blue light having a wavelength in a range of about 450 nm to 480 nm or materials that are excitable by UV light having a wavelength range 300 nm to 350 nm.

Where the phosphor materials are blue light excitable the color wheel advantageously comprises regions of phosphor materials that are operable to respectively generate red (620 nm to 750 nm) and green (495 nm to 570 nm) light. Additionally the color wheel can further comprise regions of phosphor materials that are operable to generate a secondary light color such as yellow (570 nm to 590 nm), cyan (blue and green) or magenta (blue and red). Conveniently yellow light can be generated directly using a yellow light emitting photoluminescence material whilst cyan and magenta can be respectively generated using green and red light emitting photoluminescence materials in combination with a proportion of the blue excitation light. Alternatively cyan and magenta light can be generated by sequentially combining green and blue and red and blue light. In one arrangement the disc can further comprise at least one through hole corresponding to a region of the wheel that is used for generating blue light. Such a through hole allows the periodic passage of blue light through the wheel and ensures that blue light travels along a different optical path to that of light generated by the regions of photoluminescence materials. In other arrangements regions of the color wheel that are intended to generate blue light can comprise one or more light reflective regions for selectively reflecting the blue excitation light. Preferably such regions further comprise a light scattering material such as particles of titanium dioxide, barium sulfate, magnesium oxide, silicon dioxide, aluminum oxide or mixtures thereof. Such light scattering materials can simplify the capture of light emitted from the wheel by ensuring that the emission pattern of the blue excitation light from such regions more closely resembles the emission pattern of light from regions including a photoluminescence material(s). Preferably particles of the light scattering material are combined with a light transmissive binder and deposited as a uniform thickness layer on the face of the wheel using the same process (preferably screen printing) used to deposit the photoluminescence material region(s).

Where the photoluminescence materials are UV excitable the color wheel advantageously comprises regions of photoluminescence materials that are operable to respectively generate red, green and blue light. The color wheel can further comprise regions of photoluminescence materials that are operable to respectively generate a secondary color of light including yellow, cyan or magenta light. Regions of the wheel for generating cyan light can comprise a mixture of green and blue light emitting photoluminescence materials whilst region(s) of the wheel for generating magenta light can comprise a mixture of red and blue light emitting photoluminescence materials.

To maximize light emission from the color wheel, the light reflective face of the disc has as high a reflectivity as possible and preferably has a reflectivity of at least 0.90, more preferably at least 0.95 and advantageously at least 0.98. The disc can be fabricated from a material that is intrinsically light reflective though it can alternatively comprise a disc whose surface is treated or coated to make it light reflective. To aid in the dissipation of heat and to reduce possible thermal degradation of the photoluminescence material(s) the disc is advantageously additionally thermally conductive. Advantageously the disc is fabricated from a material with as high a thermal conductivity κ as possible and preferably has a thermal conductivity of at least 150 Wm⁻¹K⁻¹ and more preferably at least 200 W·m⁻¹·K⁻¹. Typically the disc can comprise a metal or a metal alloy such as aluminum (κ≈250 W·m⁻¹·K⁻¹), an alloy of aluminum, an alloy of magnesium or copper (κ≈400 W·m⁻¹·K⁻¹). Alternatively the disc can comprise a polymer material loaded with thermally conductive particles such as for example graphite or a thermally conductive ceramic material such as for example aluminum silicon carbide (AlSiC).

In some embodiments the color wheel further comprises a light reflective border associated with the region of photoluminescence material. Such a light reflective border can aid in confining light emission from the wheel in a radial direction. In some embodiments the light reflective border can comprise a light reflective material. In one embodiment the light reflective material comprises a reflective ink material which can be printed or otherwise deposited on the face of the disc. In some arrangements the reflective border comprises a wall of a trench and in which the photoluminescence material is deposited within the trench. The trench can be formed into the surface of the disc by for example pressing, molding or machining. The wall of the trench can comprise a sloped wall, a straight substantially vertical wall, a curved convex wall, or a curved concave wall.

The reflective border can form an inner border, outer border, and/or border between different regions of the photoluminescence materials.

To increase the area of photoluminescence material that is presented to the excitation light while minimizing the projected area of photoluminescence material the photoluminescence material can comprise surface features that extend from a surface of the photoluminescence material. Such surface features can be provided by overprinting or otherwise depositing a pattern of photoluminescence material features on the region of photoluminescence region(s).

In applications requiring the color wheel to be able to generate different colors of light, the region can comprise at least two regions of different photoluminescence materials. The at least two regions of different photoluminescence materials comprise various configurations such as concentric strip regions of different photoluminescence materials that extend around the entire color wheel, multiple circular regions with alternating color photoluminescence materials, multiple circular regions with grouped color photoluminescence materials, annular regions of alternating colors of photoluminescence materials, and annular regions of grouped colors of photoluminescence materials. In some embodiments the photoluminescence material comprises a single color around the entire color wheel.

Whilst some embodiments of the present invention arose in connection with a light source for a digital projection system, other embodiments of the invention find application in other lighting applications requiring the generation of light of a selected color and high luminous flux (2000 lumens and greater) such as for example in entertainment light where high color saturation may also be beneficial.

According to another aspect of some embodiments of the invention a light source for a digital projection system comprises a solid-state light source operable to generate excitation light of a first wavelength and a color wheel in accordance with various aspects of some embodiments of the invention for generating color modulated light by selectively converting the excitation light to light of different wavelengths. Typically the solid-state light source comprises one or more laser diodes though it can comprise other solid-state sources such as one or more LEDs. The solid-state light source is configured to generate excitation light which is incident on a portion of the color wheel including the region(s) of photoluminescence materials.

The light source can further comprise a wavelength selective component operable for separating excitation light and light generated by the region(s) of photoluminescence material. Such a component can be configured to selectively prevent excitation light contributing to the emission product of the source. In one arrangement the wavelength selective component comprises a dichroic reflector that is configured to reflect light of wavelengths corresponding to the wavelength of the excitation light and to transmit light of other wavelengths. Alternatively the wavelength selective component can comprise a dichroic filter that is configured to transmit light of wavelengths corresponding to the wavelength of the excitation light and to reflect light of other wavelengths.

According to another aspect of some embodiments of the invention a method of manufacturing a color wheel for comprises the steps of: providing a disc having a light reflective face; screen printing over a first region of the light reflective face of the disc a mixture of a first photoluminescence material; and screen printing over a second region of the light reflective face of the disc a mixture of a second photoluminescence material. In one method the photoluminescence material is mixed with a light transmissive curable binder material. The binder can be UV curable and the method can further comprise at least partially curing the binder material of one region before screen printing a further region.

The method can further comprise printing on one or more further regions of the light reflective face of the disc a mixture of a light scattering material and a light transmissive binder material.

### BRIEF DESCRIPTION OF THE DRAWINGS

In order that the present invention is better understood color wheels and light sources incorporating color wheels in accordance with embodiments of the invention are described, by way of example only, with reference to the accompanying drawings in which:

FIG. 1 is a schematic of a known single-chip DLP projection system as previously described;

FIG. 2 is a schematic of a color modulated light source for a DLP projection system in accordance with an embodiment of the invention;

FIG. 3 is a schematic of the emission product of the light source of FIG. 2;

FIG. 4 is a schematic of a four color wheel in accordance with an embodiment of the invention for use in the light source of FIG. 2;

FIG. 5 is a CIE 1931 chromaticity diagram indicating the color gamut of light produced by the light source of FIG. 2;

FIG. 6 is a schematic of a color modulated light source and emission product for a DLP projection system in accordance with another embodiment of the invention;

FIG. 7 is a schematic of a six color wheel in accordance with an embodiment of the invention for use in the light source of FIG. 6;

FIG. 8 is a schematic of a six color wheel in accordance with a further embodiment of the invention;

FIG. 9 is a schematic illustrating the isotropic nature of light generation by a color wheel;

FIG. 10 show schematics of a color wheel having reflective borders adjacent to phosphor materials;

FIG. 11 is a schematic illustrating the effect of light reflective borders on the emitted light;

FIG. 12A is a schematic illustrating possible loss of emitted light from the color wheel;

FIG. 12B is a schematic illustrating the use of light reflective borders to reduce loss of emitted light from color wheel;

FIGS. 13A-E are schematics illustrating different approaches of using a trench to reduce loss of emitted light from the color wheel;

FIG. 14A is a schematic of a color wheel having surface features formed on the phosphor materials;

FIG. 14B is a schematic of a color wheel having surface features formed on the phosphor materials, with reflective borders to reduce loss of emitted light from the color wheel;

FIG. 14C is a schematic of a color wheel having surface features formed on the phosphor materials, with usage of a trench to reduce loss of emitted light from the color wheel;

FIG. 15 is a schematic of a single color wheel;

FIG. 16 is a schematic of a color wheel having multiple strips of phosphor materials, where each strip corresponds to a single color;

FIG. 17 is a schematic of a color wheel having circular regions of phosphor materials, where different regions having the same color are grouped together;

FIG. 18 is a schematic of a color wheel having circular regions of phosphor materials, where colors for the regions alternate around the color wheel; and

FIG. 19 is a schematic of a color wheel having reflective borders between adjacent phosphor materials on the color wheel.

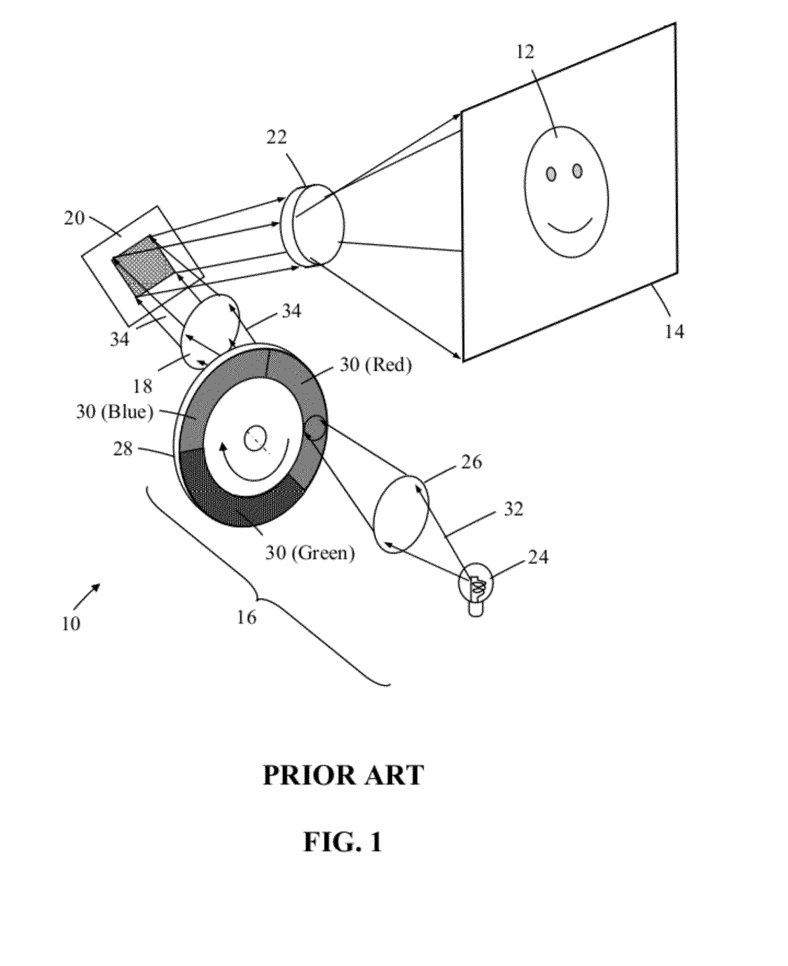

### DETAILED DESCRIPTION OF THE INVENTION

Throughout this patent specification like reference numerals are used to denote like parts. For the purposes of illustration only, the following description is made with reference to photoluminescence material embodied specifically as phosphor materials. However, the invention is applicable to any type of photoluminescence material, such as phosphor materials and quantum dots. A quantum dot is a portion of matter (e.g. semiconductor) whose excitons are confined in all three spatial dimensions that may be excited by radiation energy to emit light of a particular wavelength or range of wavelengths. As such, the invention is not limited to phosphor based wavelength conversion components unless claimed as such.

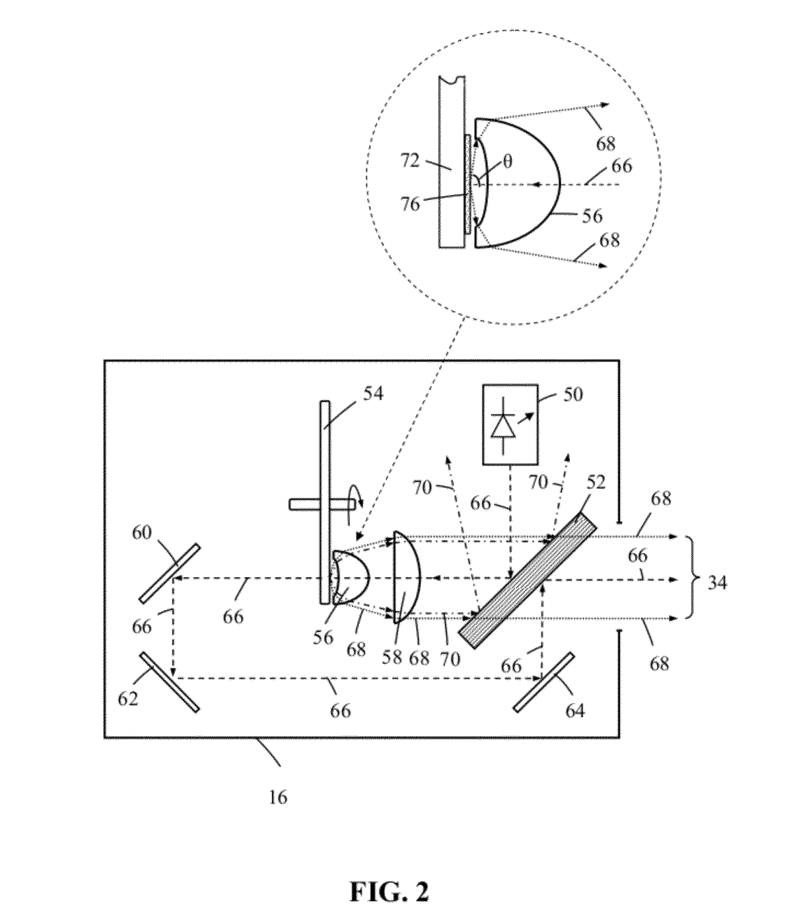

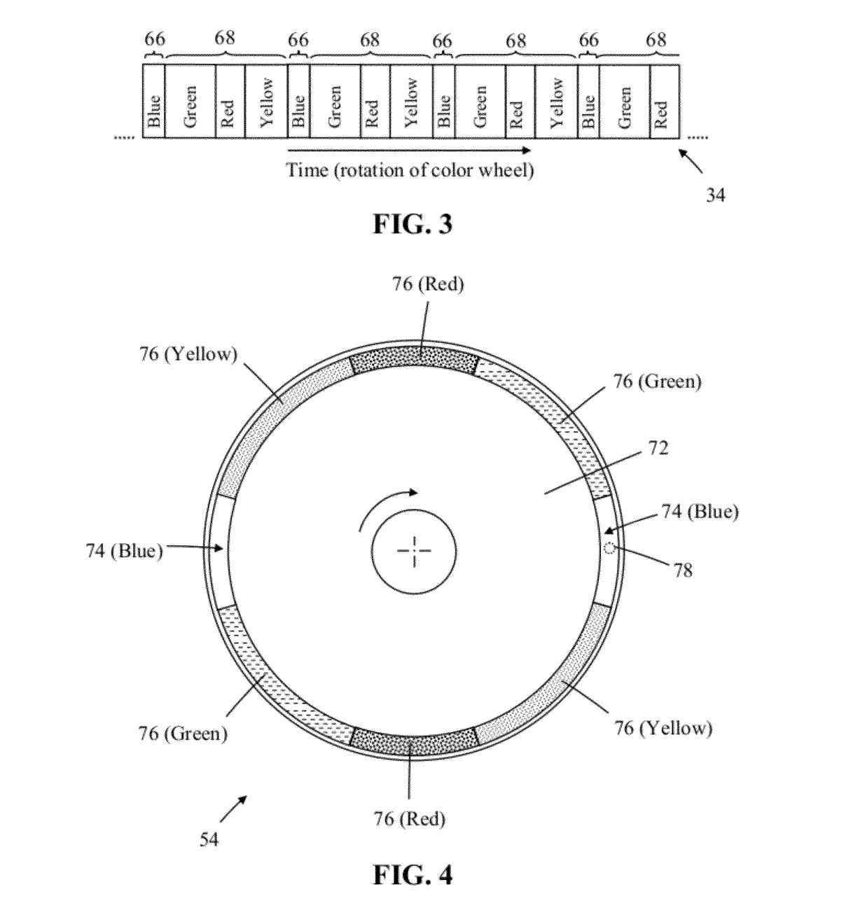

A color modulated light source 16 for a digital projection system in accordance with an embodiment of the invention is now described with reference to FIG. 2. As shown in FIG. 3 the light source 16 is operable to generate a color modulated emission product 34 comprising a time multiplexed sequence of blue, green, red and yellow light. Typically the light source is configured to generate an emission product with a luminous flux of 2000+ lumens and an operating lifetime of more than 15,000 hours. The light source 16 is intended for use in a single-chip DLP projection system such as a DLP front projector or a DLP rear projection television.

Referring to FIG. 2 the light source 16 comprises a solid-state light source 50, a dichroic reflector 52, a color wheel 54, a collecting optic 56, a collimating optic 58 and planar reflectors 60, 62, 64. The solid-state light source 50 preferably comprises a laser diode that is operable to generate blue light 66 with a peak wavelength of order 445 nm. An example of a suitable source 50 would be an array of twenty 1.6 W GaN-based (gallium nitride) laser diodes from Nichia Corporation of Japan. Alternatively the light source 50 can comprise one or more high intensity LEDs (Light Emitting Diodes).

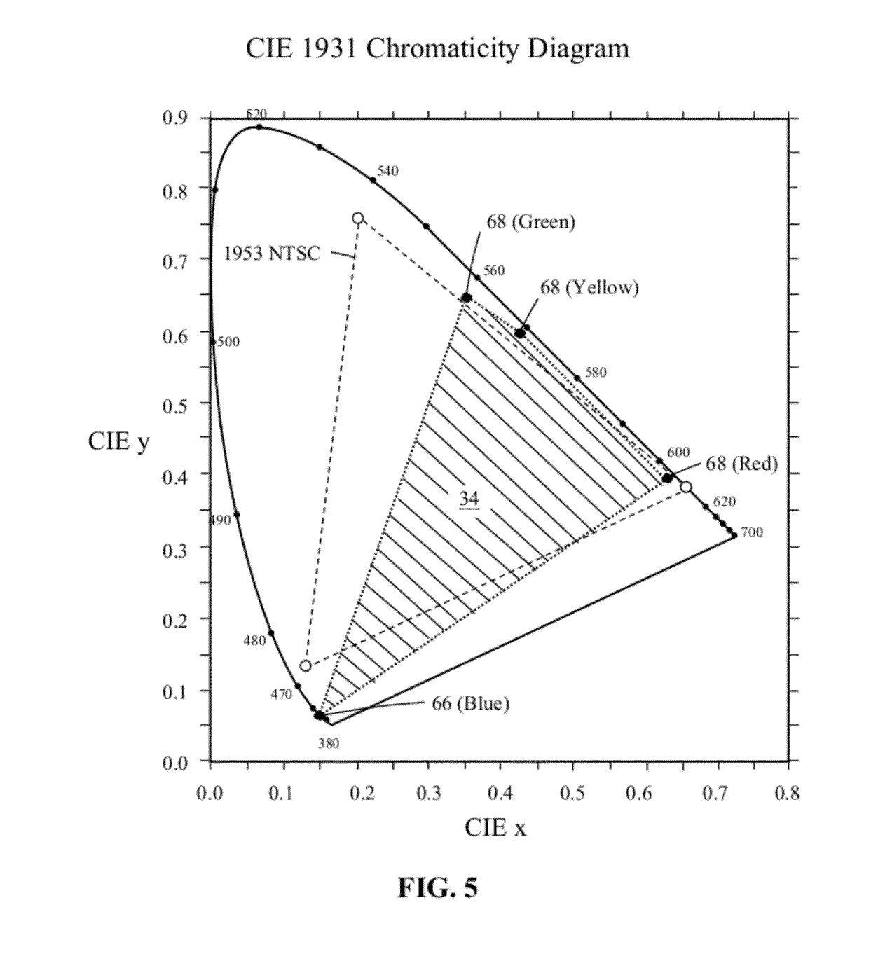

The color wheel 54, which is described in detail below, comprises a light reflective disc and includes a number of regions (annular sectors) of blue light excitable phosphor materials (76—FIG. 4) that are configured to convert, by a process of photoluminescence, blue excitation light 66 generated by the source 50 into green, red and yellow colored light 68. Regions of the wheel associated with generating blue light 66 comprise an aperture (through hole 74—FIG. 4) that, with rotation of the wheel, periodically allows blue light to pass through the wheel.

The dichroic reflector or interference reflector 52 typically comprises a light transmissive substrate having an interference filter composed of multiple layers of different refractive index materials deposited on its surface. The dichroic reflector 52 is configured to have a reflection waveband that reflects light of wavelengths corresponding to those generated by the solid-state source 50 (i.e. blue in this example) whilst allowing light of other colors (wavelengths) to pass substantially unattenuated through the reflector.

In operation blue excitation light 66 generated by the source 50 that is incident on a first face of the dichroic reflector 52 is reflected by the dichroic reflector 52 and directed through the collimating 58 and the collecting optics 56 onto the peripheral portion of the color wheel 54 containing the regions of phosphor materials 76 and aperture(s) 74. During the time interval that the aperture 74 passes through the path (78—FIG. 4) of the blue excitation light 66, the blue light passes through the wheel 54 and is directed by the reflectors 60, 62, 64 onto the opposite face of the dichroic mirror 52 which reflects the light to contribute to the emission product 34 of the source. In FIG. 2 the path of blue light 66 contributing to the emission product is indicated by dashed lines. During the time intervals that the sector of phosphor material passes through the path of the blue excitation light 66 the excitation light is absorbed by the phosphor material and re-emitted as light 68 of a different color (wavelength). The path of phosphor generated light (phosphor light) 68 is indicated by dotted lines in FIG. 2. Since the photoluminescence process is isotropic, light 68 will be emitted equally in all directions. Phosphor generated light 68 that is emitted in directions towards the color wheel will be reflected by the reflective disc in a direction back towards the dichroic filter. It is believed that on average as little as 1 in 1000 interactions of a photon with a phosphor material particle results in absorption and generation of photo luminescence light 68. The majority, about 99.9%, of interactions of photons with a phosphor particle result in scattering of the photon. As a result a proportion of blue light 70 will also be scattered by the phosphor regions of the color wheel in a direction towards the dichroic reflector. In FIG. 2 the path of such light 70 is indicated by dashed-dot lines. As shown the collecting optic 56 can comprise a positive meniscus lens that is configured to gather light (a combination of phosphor generated light 68 and scattered/reflected blue light 70) emitted from the color wheel over as large a solid angle as possible typically over a solid angle Ω of approximately π steradians (i.e. a cone of apex θ≈60°: see inset in FIG. 2). The collimating optic 58 which can comprise a plano-convex lens collimates the light 68, 70 into a substantially parallel beam that is incident on the first face of the dichroic reflector 52. The phosphor light 68 portion that strikes the dichroic reflector 52 passes through the dichroic reflector and contributes to the emission product 34 of the source. Since the scattered blue light 70 is of a wavelength corresponding to the reflection waveband of the dichroic reflector 52, the dichroic reflector blocks such light from contributing to the emission product by reflecting the light in a direction towards the source 50.

Referring to FIG. 4 the color wheel 54 comprises a circular disc 72 having a highly light reflective face (i.e. a reflectivity of at least 0.90). An example of a suitable disc material is Anolux Micro-SILVER® from Anomet Inc, Ontario, Canada; a high reflectivity (>98%) sheet aluminum. The disc can be fabricated from a material that is intrinsically light reflective though it can alternatively comprise a disc whose surface is treated or otherwise coated to make it light reflective. To aid in the dissipation of heat and to reduce possible thermal degradation of the phosphor materials the disc 72 is preferably additionally thermally conductive and has as high a thermal conductivity as possible to aid in the dissipation of heat generated during the photoluminescence process. Preferably the disc is fabricated from a material with a thermal conductivity κ of at least 150 W·m⁻¹·K⁻¹ and more preferably at least 200 W·m⁻¹·K⁻¹. Typically the disc can comprise a metal or a metal alloy such as aluminum (κ≈250 W·m⁻¹·K⁻¹), an alloy of aluminum, an alloy of magnesium or copper (κ≈400 W·m⁻¹·K⁻¹). Alternatively the disc can comprise a polymer material loaded with thermally conductive particles or a thermally conductive ceramic material such as for example aluminum silicon carbide (AlSiC).

As described the color wheel 54 can comprise one or more sector shaped apertures (through holes) 74 to allow the periodic the passage of blue light through the wheel. The color wheel further comprises regions, typically annular sectors or circular sectors, of different blue light excitable phosphor materials 76 (Green), 76 (Red), 76 (Yellow) that are operable to respectively generate green, red and yellow light. In one arrangement the region of green phosphor material 76 (Green) comprises an aluminate-based phosphor material that is operable to generate green light with a peak wavelength λₚ in a range 520 nm to 548 nm. The region of red phosphor material 74 (Red) can comprise a nitride phosphor that is operable to generate red light with a peak wavelength λₚ in a range 608 nm to 635 nm whilst the regions of yellow phosphor material 74 (Yellow) can comprise a YAG-based (yttrium aluminum garnet) phosphor material that is operable to generate light with a peak wavelength λₚ in a range 560 nm to 573 nm. Examples of suitable phosphor materials from Internatix Corporation of Fremont, Calif. are given in TABLE 1.

TABLE 1
Selected Intematix Corporation phosphor materials

| | | | | Peak |
|---|---|---|---|---|
| Emission | | | | wavelength |
| Color | Product | Composition | 1931 CIE (x, y) | λₚ (nm) |
| Green | GAL530 | Aluminate | 0.347, 0.573 | 530 |
| Green | GAL545 | Aluminate | 0.395, 0.555 | 545 |
| Red | R6436 | Nitride | 0.634, 0.366 | 630 |
| Red | R6535 | Nitride | 0.643, 0.356 | 640 |
| Red | R6634 | Nitride | 0.654, 0.356 | 650 |
| Red | R6733 | Nitride | 0.672, 0.327 | 655 |
| Red | R6832 | Nitride | 0.682, 0.317 | 660 |
| Red | R6931 | Nitride | 0.694, 0.305 | 670 |
| Yellow | NYAG4156 | Ce doped YAG | 0.406, 0.557 | 545 |
| Yellow | NYAG4355 | Ce doped YAG | 0.426, 0.548 | 551 |
| Yellow | NYAG4454 | Ce doped YAG | 0.444, 0.536 | 558 |
| Yellow | NYAG4653 | Ce doped YAG | 0.458, 0.526 | 562 |

It will be appreciated that the regions of phosphor material 76 can comprise a mixture of two or more phosphor materials. In preferred embodiments the regions of phosphor material 76 are screen printed on the disc 72 using a photoluminescence composition comprising a slurry of the powdered phosphor material(s) and a light transmissive curable liquid binder material. Since the photoluminescence composition is printable it will, for the sake of brevity, be referred to as “phosphor ink”. Typically the regions of phosphor materials are printed so that there is no overlap of neighboring regions and the regions are preferably printed such that neighboring regions abut one another.

The phosphor ink binder can comprise a curable liquid polymer such as a polymer resin, a monomer resin, an acrylic-poly(methyl methacrylate) (PMMA), an epoxy (polyepoxide), a silicone or a fluorinated polymer. It is important that the binder material is, in its cured state, transmissive to all wavelengths of light generated by the phosphor material(s) and the solid-state light source and preferably has a transmittance of at least 0.9 over the visible spectrum (380 nm to 800 nm). The binder material is preferably U.V. curable though it can be thermally curable, solvent based or a combination thereof. U.V. or thermally curable binders can be preferable because, unlike solvent-based materials, they do not “outgas” during polymerization. When a solvent evaporates the volume and viscosity of the phosphor ink will change resulting in a higher concentration of phosphor material which can affect the emission color of light generated by the region. With U.V. curable polymers, the viscosity and solids ratios are more stable during the deposition process with U.V. curing used to polymerize and solidify the layer after deposition is completed. Moreover since in the case of screen printing of the phosphor ink multiple-pass printing may be required to achieve a required layer thickness, the use of a U.V. curable binder is preferred since each layer can be cured virtually immediately after printing prior to printing of the next layer.

The color of light 68 generated by each phosphor material region 76 will depend on the phosphor material composition whilst the amount of photoluminescence light will depend on the quantity of phosphor material per unit area. It will be appreciated that the quantity of phosphor material per unit area is dependent on both the thickness of the phosphor ink layer and the weight loading of phosphor material to binder. It has been found that the key parameters that affect the color wheel's optical and thermal performance are the quantity of phosphor material per unit area and the thickness of the phosphor material regions. For example if the thickness of the phosphor material region is increased above a certain thickness the optical efficiency of the region will decrease due to the absorption of photoluminescence light by the phosphor material layer. Conversely if the thickness of the phosphor ink layer is too thin the optical efficiency will also decrease since only a small proportion of the excitation light will be converted to photoluminescence light. Due to the isotropic nature of the photoluminescence process the thickness and quantity of phosphor material per unit area are selected to allow the photoluminescence light that is generated in a direction towards the disc to pass through the phosphor material layer and to be reflected by the disc and to contribute to the emission product. In terms of thermal performance the disc 72 is a good thermal conductor (κ≧150 W·m⁻¹·K⁻¹) whilst the phosphor ink binder is a poor thermal conductor (e.g. κ<0.2 W·m⁻¹·K⁻¹ for acrylic). As a result phosphor material on the surface of layer (i.e. the phosphor material furthest from the face of the disc) can become thermally isolated if the phosphor ink layer is too thick resulting in thermal degradation of the phosphor material. For optimal performance the quantity of phosphor material per unit area is in a range of about 10 mg·cm⁻² to about 50 mg·cm⁻² and more preferably in a range 30 mg·cm⁻² to 35 mg·cm⁻² whilst the thickness of the phosphor material regions is in a range 40 μm to 120 μm and more typically in a range 60 μm to 80 μm. The quantity of phosphor material per unit area for each region can be controlled by varying the screen size and/or number of print passes used to deposit the region. Alternatively the weight of phosphor material per unit area can be altered by varying the weight loading of phosphor material to binder. To enable printing of the phosphor material regions in a minimum number of print passes the phosphor ink preferably has as high a solids loading of phosphor material to binder material as possible and preferably has a weight loading in a range 40% to 75%. A high phosphor material weight loading is further advantageous in maximizing the conduction of heat from the phosphor material to the disc by minimizing the total quantity of binder which as described is typically a poor thermal conductor. It has been found that above about a 75% weight loading it can be difficult to ensure strong cohesion, adhesion and maintain printability of the phosphor ink. For weight loadings below about 40% it is found that five or more print passes may be necessary to achieve a required phosphor material per unit area. Furthermore for weight loadings below about 40% it has been noted that there can be a poor transfer of heat from the phosphor material region to the thermally conductive disc which can result in thermal degradation of the phosphor material. It is to be noted that in phosphor inks of some embodiments of the invention the weight loading of phosphor material to binder material is much higher that weight loading of pigment in a conventional screen print ink. The phosphor material comprises particles with an average particle size of 10 μm to 20 μm and typically of order 15 μm.

The viscosity of the phosphor ink is determined by the viscosity of the binder material and weight loading of phosphor material. The binder material preferably has a viscosity in a range 1 Pa·s to 2.5 Pa·S (1000 to 2500 cps). For screen printing the binder material preferably has a viscosity in a range 0.1 to 5 Pa·s (100 to 5000 cps) and preferably about 1 Pa·s to 2.5 Pa·S (1000 to 2500 cps). Thinning additives can be used during initial formulation of the phosphor ink to achieve a required viscosity and to “thin” the phosphor ink during printing. However care must exercised when thinning to maintain the solids loading since it is the phosphor material content (loading) and layer thickness, not viscosity, that affects the color of light generated by the phosphor ink.

As well as viscosity the surface tension of the binder material can affect the phosphor ink's performance. For example if the surface tension of the phosphor ink is too high, bubbles can form during printing resulting in poor layer formation. Bubbles can also form in phosphor inks with a low surface tension and it is preferred to additionally add a de-foaming agent to the phosphor ink. Whilst it is preferred to screen print the phosphor ink other deposition methods and printing techniques can be used to deposition the regions of phosphor material.

The phosphor material can comprise an inorganic or organic phosphor such as for example silicate-based phosphor of a general composition A₃Si(O,D)₅ or A₂Si(O,D)₄ in which Si is silicon, O is oxygen, A comprises strontium (Sr), barium (Ba), magnesium (Mg) or calcium (Ca) and D comprises chlorine (Cl), fluorine (F), nitrogen (N) or sulfur (S). Examples of silicate-based phosphors are disclosed in U.S. Pat. No. 7,575,697 B2 “Silicate-based green phosphors” (assigned to Internatix Corp.), U.S. Pat. No. 7,601,276 B2 “Two phase silicate-based yellow phosphors” (assigned to Internatix Corp.), U.S. Pat. No. 7,655,156 B2 “Silicate-based orange phosphors” (assigned to Internatix Corp.) and U.S. Pat. No. 7,311,858 B2 “Silicate-based yellow-green phosphors” (assigned to Internatix Corp.). The phosphor can also comprise an aluminate-based material such as is taught in our co-pending patent application US2006/0158090 A1 “Novel aluminate-based green phosphors” and U.S. Pat. No. 7,390,437 B2 “Aluminate-based blue phosphors” (assigned to Internatix Corp.), an aluminum-silicate phosphor as taught in co-pending application US2008/0111472 A1 “Aluminum-silicate orange-red phosphor” or a nitride-based red phosphor material such as is taught in our co-pending United States patent application US2009/0283721 A1 “Nitride-based red phosphors” and US2010/0308712 A1 “Nitride-based red-emitting in RGB red-green-blue lighting systems”. It will be appreciated that the phosphor material is not limited to the examples described and can comprise any phosphor material including nitride and/or sulfate phosphor materials, oxy-nitrides and oxy-sulfate phosphors, Garnet structured phosphor materials or YAG materials.

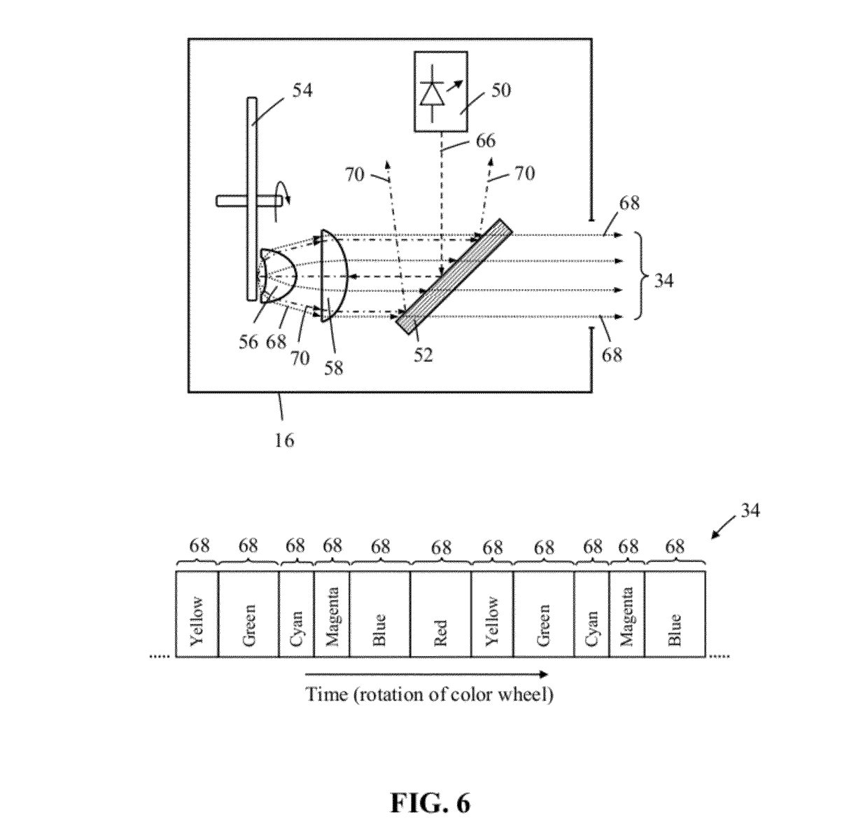

FIG. 5 is a CIE (Commission Internationale de l'éclairage) 1931 chromaticity diagram indicating the color gamut of light 34 that the source can generate. In FIG. 5 solid dots indicate the blue 66, green 68 (Green), red 68 (Red) and yellow 68 (Yellow) light generated by the source and the cross hatched area bounded by straight lines connecting the dots indicates the color gamut for the source. For comparison the 1953 NTSC (National Television System Committee) color standard is shown in FIG. 5.

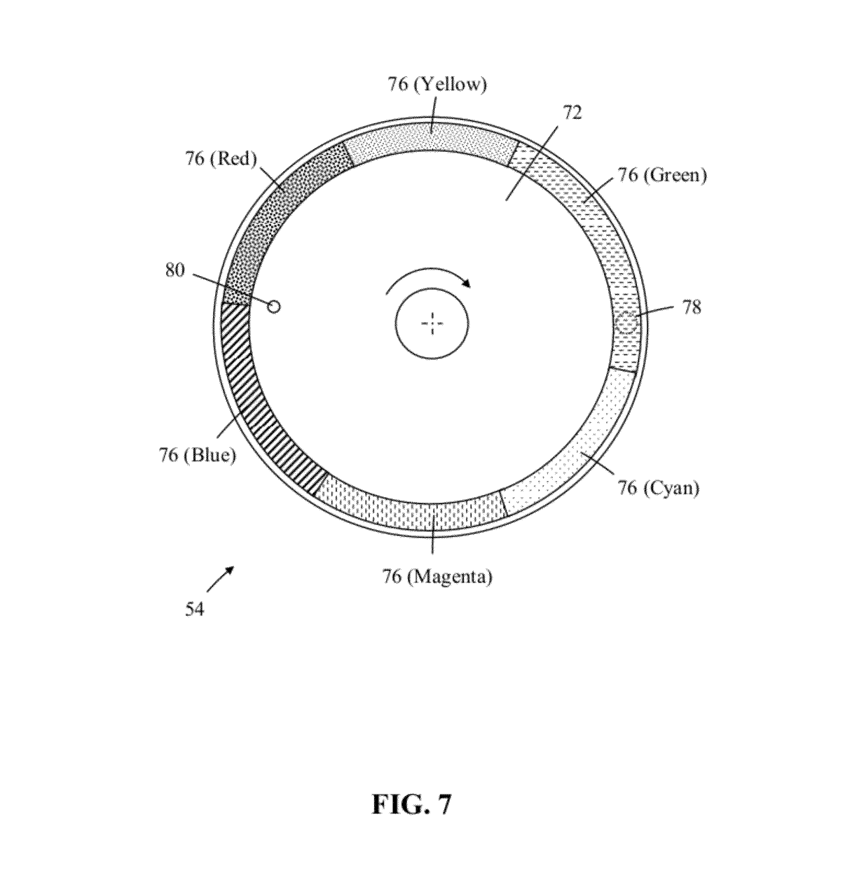

An example of a six color modulated light source 16 for a digital projection system in accordance with another embodiment of the invention is shown in FIG. 6. The light source 16 is operable to generate a color modulated light output 34 comprising a time multiplexed sequence of yellow, green, cyan, magenta, blue and red light with a luminous flux of 2000+ lumens and a operating lifetime of more than 15,000 hours. In this exemplary embodiment the solid-state light source 50 is operable to generate UV (ultra violet) excitation light 66 with a peak wavelength in a range 300 nm to 350 nm and the regions of phosphor material 76 comprise UV excitable phosphor materials. In such a light source the dichroic reflector 52 is configured to have a reflection waveband in the UV range to block scattered excitation light 70 contributing to the emission product 34.

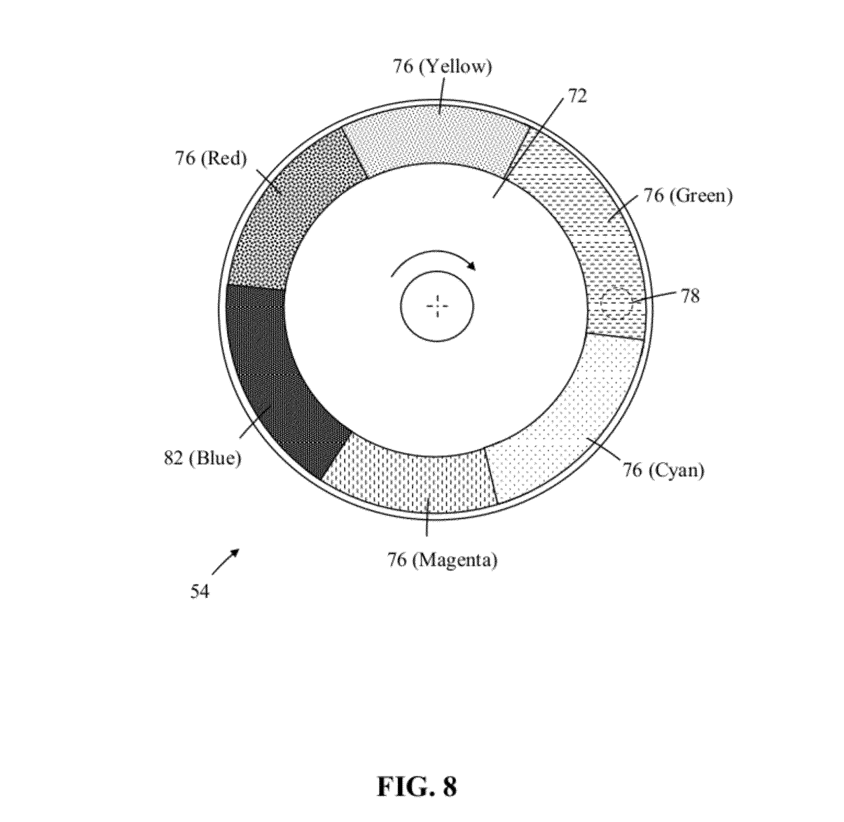

FIG. 7 is a schematic of a six color wheel 54 in accordance with an embodiment of the invention for use in the light source of FIG. 6. The color wheel 54 comprises a light reflective circular disc 72 and regions, typically annular sectors or circular sectors, of different UV excitable phosphor materials 76 (Yellow), 76 (Green), 76 (Cyan), 76 (Magenta), 76 (Blue) and 76 (Red) that are operable to absorb the excitation light 66 and respectively generate yellow, green, cyan, magenta, blue and red colored light. Since the excitation light 66 does not contribute to the emission product 34 the color wheel further comprises a region of blue light emitting 76 (Blue) phosphor material that is operable to generate blue light with a peak wavelength πₚ in a range 450 nm to 480 nm. The phosphor material region 76 (Cyan) for generating cyan colored light can comprise a mixture of blue and green light emitting phosphor materials whilst the phosphor material region 76 (Magenta) for generating magenta colored light can comprise a mixture of blue and red light emitting phosphor materials. To enable operation of the DMD 20 to be synchronized with the color wheel, the color wheel can include one or more index holes 80.

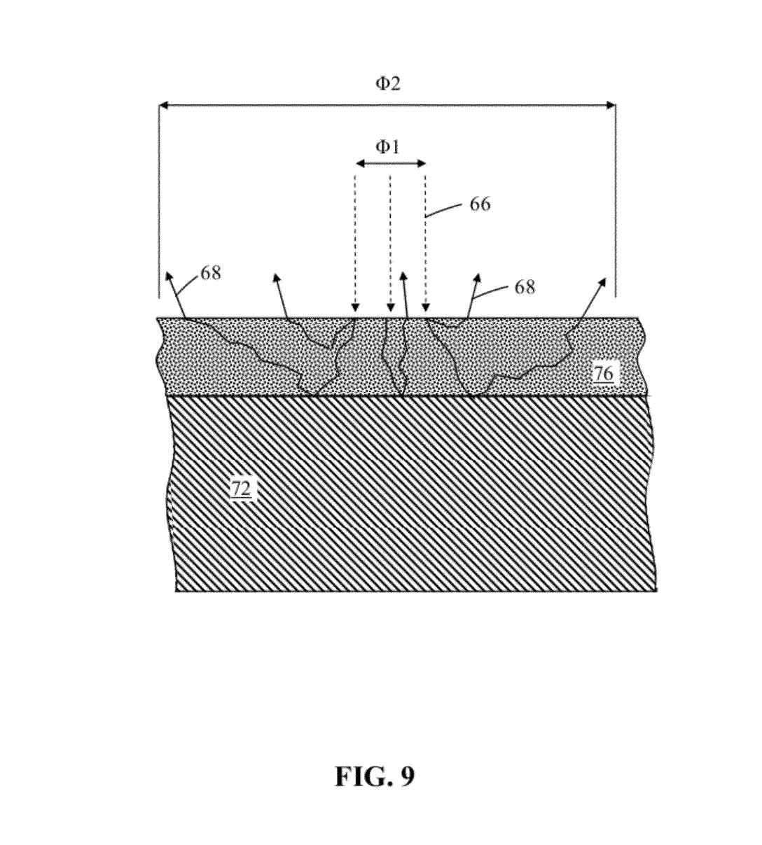

It will be appreciated that the invention is not limited to the exemplary embodiments described and that variations can be made within the scope of the invention. For example it is envisioned in further embodiments to use a light reflective region(s) or sector(s) 82 (FIG. 8), rather than a window 74 (FIG. 4), for blue light generating region(s) of the color wheel. In such arrangements a time dependent wavelength selective element, such as a light transmissive wheel comprising dichroic filter sectors corresponding to the sectors of the color wheel other than blue, can be used to selectively block blue light. Moreover at blue light generating sectors of the wheel, particles of a light scattering material can be provided to ensure that the emission of light from such sectors more closely resemble the emission pattern of light from sectors containing a phosphor material. In one arrangement the light scattering material comprises particles of titanium dioxide (TiO₂) though it can comprise barium sulfate (BaSO₄), magnesium oxide (MgO), silicon dioxide (SiO₂) or aluminum oxide (Al₂O₃). So that the sector(s) of the wheel corresponding to the generation of blue light scatter light in a way that closely resembles sectors containing a phosphor material, the light scattering material is preferably mixed with a light transmissive binder and applied to the sector using the same method, preferably screen printing, to apply the phosphor materials.

As shown in FIG. 8 it is further envisioned to provide a six color wheel 54 based on blue light excitable phosphor materials in which regions 76 (Cyan), 76 (Magenta) for generating cyan and magenta colored light respectively comprise green and red light emitting phosphor materials. Since such regions require the contribution of the blue excitation light to generate the selected light color, the quantity of phosphor material per unit area for such regions is correspondingly lower ensuring that only a selected portion of the excitation light is absorbed by the phosphor material whilst the remainder is scattered and contributes to the light output. As with the blue light generating sectors a time dependent dichroic filter element is required to allow blue light to contribute to the emission product.

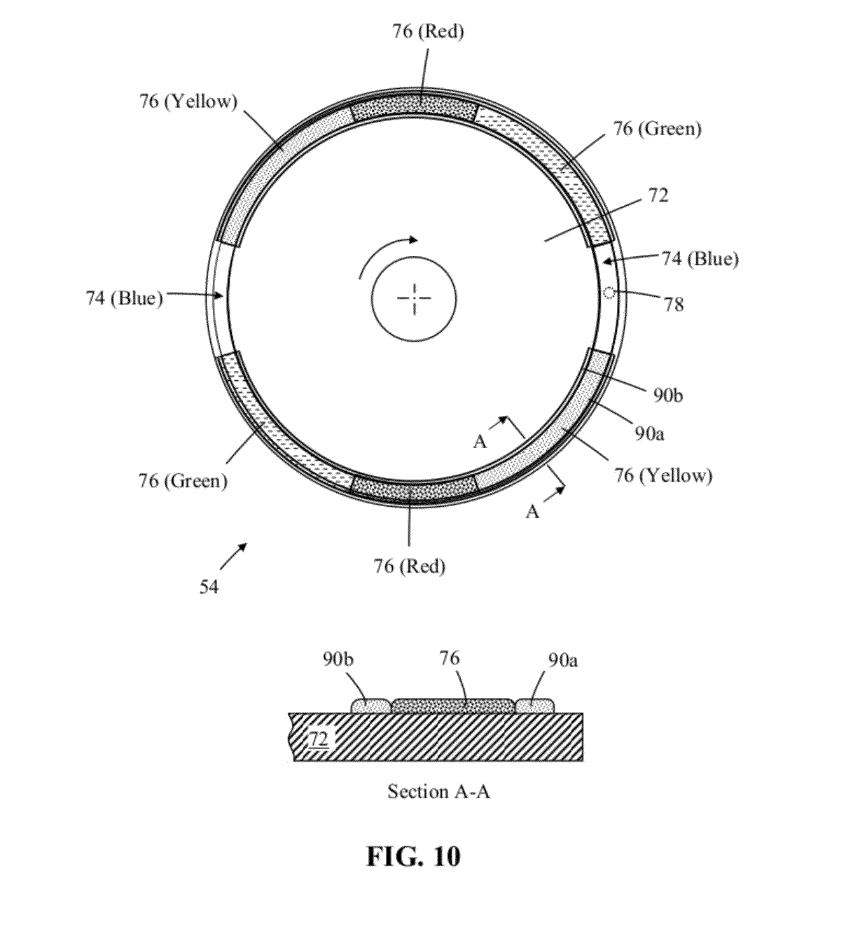

The light generated from the phosphor materials is not necessarily going to be emitted and/or reflected directly back to the excitation light source. Instead, because the photoluminescence process is isotropic, the phosphor generated light is emitted isotropically in all directions. To explain, consider the diagram shown in FIG. 9, which illustrates an excitation light source (such as a solid-state laser) that produces a laser spot for the excitation light 66 having a diameter φ1. This produces phosphor generated light 68 from the phosphor material 76. However, only a portion of the phosphor generated light 68 will be emitted back in the direction of the excitation light source within the area defined by φ1. The majority of both excitation light and phosphor generated light 68 is likely to be scattered by the phosphor material particles in various directions, forming a phosphor spot having a diameters of φ2, where the diameter φ2 of the phosphor spot is significantly larger than the diameter of the laser spot φ1. For example for an excitation spot of diameter φ1 of about 2.3 mm the spot of phosphor generated light has a diameter φ2 of about 12 mm.

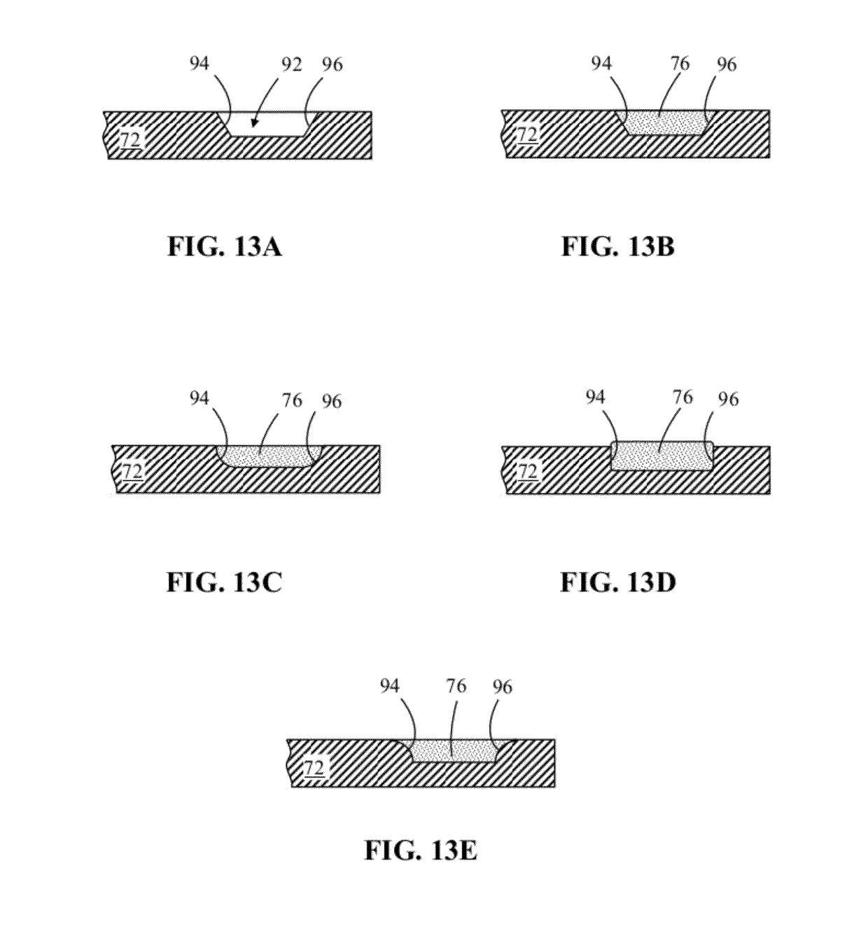

As shown in FIG. 12A, the problem is that this isotropic characteristic may cause some of the emitted light 68 from the phosphor material 76 to be emitted in directions that are not captured by the optical components 56 and 58 and consequently do not to contribute to the output of the source. As a result, this loss of the emitted light 68 reduces the efficiency of the light source 16, producing an emission product having less luminous flux than would be reasonably expected given the power usage and materials costs of the light source 16.

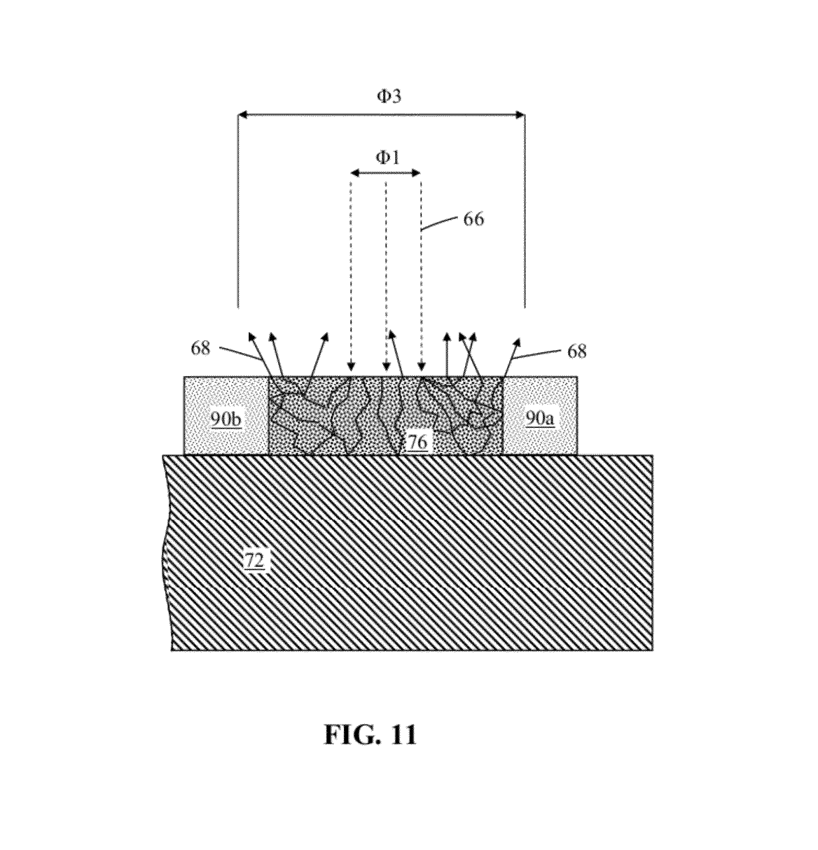

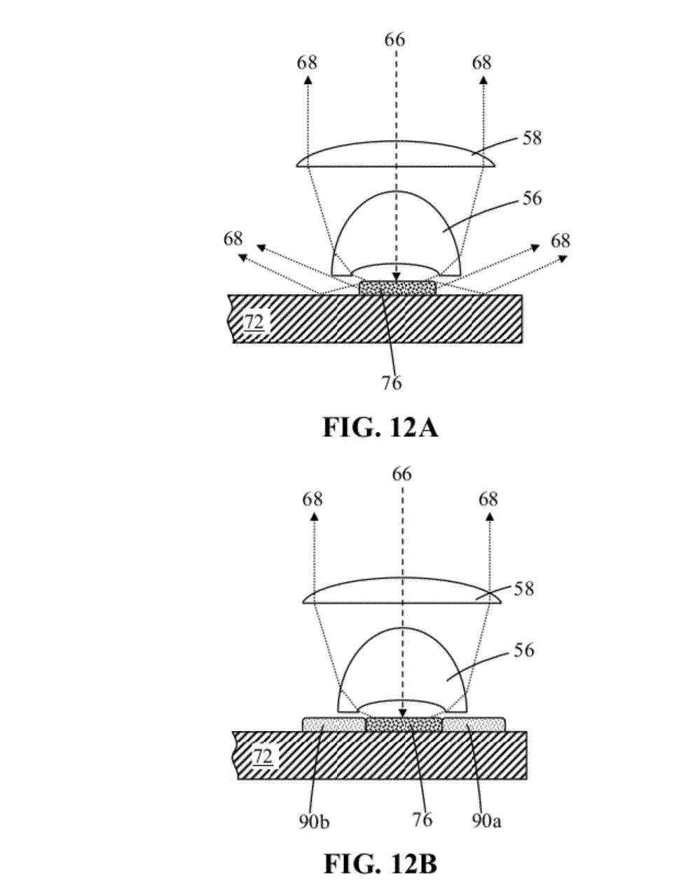

To address this issue, FIG. 10 illustrates an embodiment of the invention in which the phosphor material 76 on the color wheel 54 is bordered by an outer reflective material 90a and an inner reflective material 90b. Each of the outer reflective material 90a and the inner reflective material 90b forms a strip of light reflective material that functions to reflect any light generated by the phosphor material 76 away from the direction of the outer reflective material 90a and the inner reflective material 90b. In effect, a “wall” is built that physically limits the size of the phosphor spot in a radial direction. As shown in FIG. 11, the effect of this configuration is to constrain the emitted light to much smaller emission diameter φ3. This therefore causes the emitted light 68 from phosphor material 76 that would otherwise emit in non-useful directions to be reflected away from the direction of the outer reflective material 90a and the inner reflective material 90b into directions that can be captured by the optical components 56 and 58.

As shown in FIG. 12B, the emitted light 68 from phosphor material 76 that would otherwise emit in non-useful directions would be reflected away from the direction of the outer reflective material 90a and the inner reflective material 90b, and redirected through the optical components 56 and 58 to contribute to the light output of the source. As a result, the efficiency of the light source 16 is significantly improved since there is less light leakage, producing an emission product having greater luminous flux. This means that loss of the emitted light can be significantly reduced and/or eliminated by deploying the outer reflective material 90a and the inner reflective material 90b at the border of the phosphor material 76. This allows the light source 16 to produce an emission product having higher luminous flux, providing more efficient power usage and materials costs for the light source 16.

The outer reflective material 90a and the inner reflective material 90b can be formed on the color wheel using any suitable manufacturing process. In some embodiment, each of the outer reflective material 90a and the inner reflective material 90b can be formed by depositing a reflective ink material, e.g. using a printing process similar to that used to deposit the phosphor material 76. Any reflective ink material (e.g. a white ink) can be employed. In some embodiments, a light reflective silicone material is used as the reflective material, such as the silicone-based Dam product available from Shin-Etsu Chemical Company Ltd.

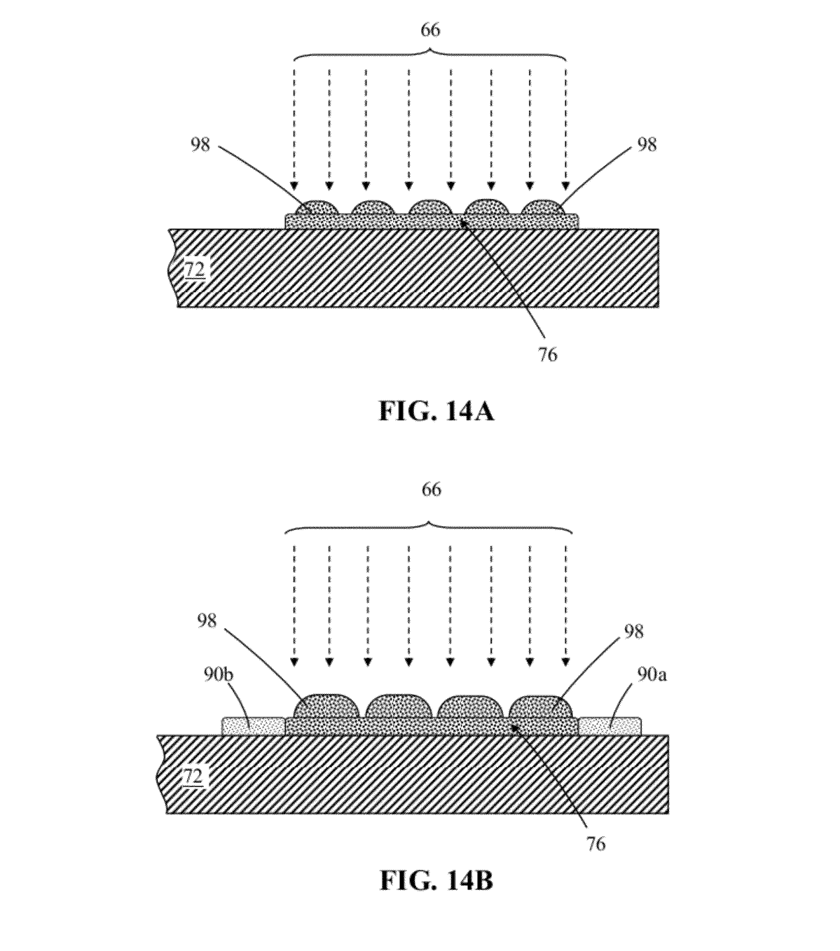

An alternative approach is shown in FIG. 13A, in which a channel or trench 92 formed in the color wheel 54. As shown in FIG. 13B, the phosphor material 76 is deposited within the trench 92 in the color wheel 54 and the walls of the trench 92 provide a reflective barrier to prevent leakage of light 68 that is emitted from the phosphor material 76. Like the approach of FIG. 10, the embodiment of FIGS. 13A-B prevents or at least reduces light loss, since the walls 94 and 96 reflect light in a more desirable direction, which serves to increase the overall light-producing efficiency of the light source 16. Therefore, the outer wall 94 and inner wall 96 of the channel 92 in FIG. 13A-B correspond to the outer reflective material 90a and the inner reflective material 90b, respectively, of FIG. 10.

While the walls 94 and 96 in FIGS. 13A-B are specifically illustrated with a sloped configuration, it is noted that any number of wall configurations may be employed in embodiments of the invention. For example, FIG. 13C shows an alternate embodiment in which the walls 94 and 96 have a curved concave configuration. FIG. 13D shows an embodiment in which the walls 94 and 96 have a straight vertical configuration. FIG. 13E shows an alternate embodiment in which the walls 94 and 96 have a curved convex configuration.

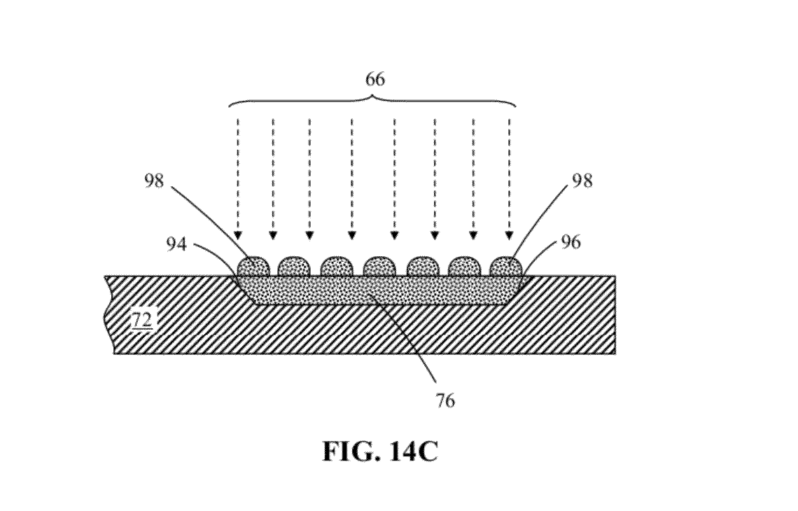

FIG. 14A illustrates an approach to improve the photoluminescence process to generate greater amounts of emitted light from phosphor material 76. The exterior face of phosphor material 76 is configured to include one or more surface features 98 that extend or protrude toward the direction of excitation light 66 (e.g. blue light or UV light) generated by a light source 50. The surface features 98 provide a greater amount of surface area for the phosphor material 76 to interact with the excitation light 66. Since the photoluminescence light 68 is generated by interactions of photons from the excitation light 66 with phosphor particles in the phosphor material 76, this means that increasing the surface area of the phosphor material 76 will increase the likelihood of light-emitting interaction event. As a result a proportion of blue light 70 that is produced increases with the presence of the surface features 98. The surface features 98 can be formed with any suitable shape. For example, surface features 98 can be formed with dome shapes. Typically the features can be formed by overprinting the phosphor region with a pattern of dots.

This approach can also be used in conjunction with a physical barrier to constrain the size of the phosphor spot. For example, FIG. 14B shows an embodiment in which the phosphor material 76 having one or more surface features 98 is bordered by outer reflective material 90a and an inner reflective material 90b, where each of these reflective materials 90a and 90b forms a strip of light reflective material that functions to reflect any light generated by the phosphor material 76 away from the direction of the outer reflective material 90a and the inner reflective material 90b. FIG. 14C shows another embodiment in which the phosphor material 76 having one or more surface features 98 is deposited within a trench 92, where the walls 94 and 96 of the trench 92 provide a reflective barrier to prevent leakage of light 68 that is emitted from the phosphor material 76.

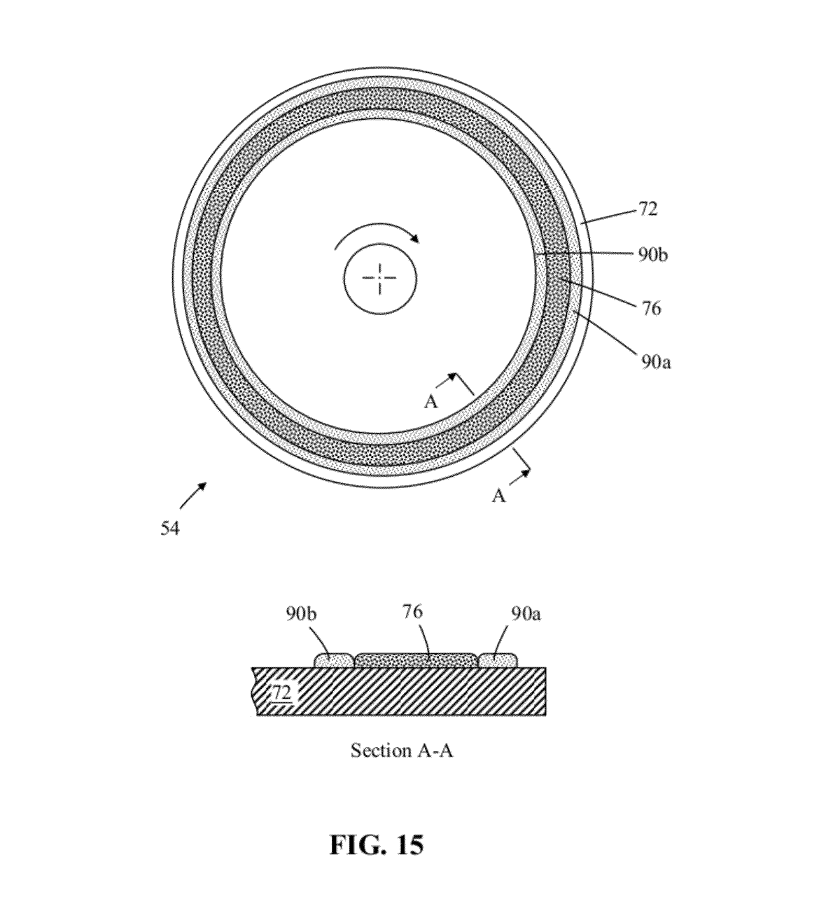

FIG. 15 illustrates another embodiment having a single-color phosphor material 76 that extends around the entire color wheel 54. As before the phosphor material 76 is bordered by the outer reflective material 90a and the inner reflective material 90b which reduces or eliminates light leakage. Multiple ones of this type of color wheel 54 could be employed in a light source 16, where each of the plurality of color wheels 54 would correspond to phosphor materials having different colors.

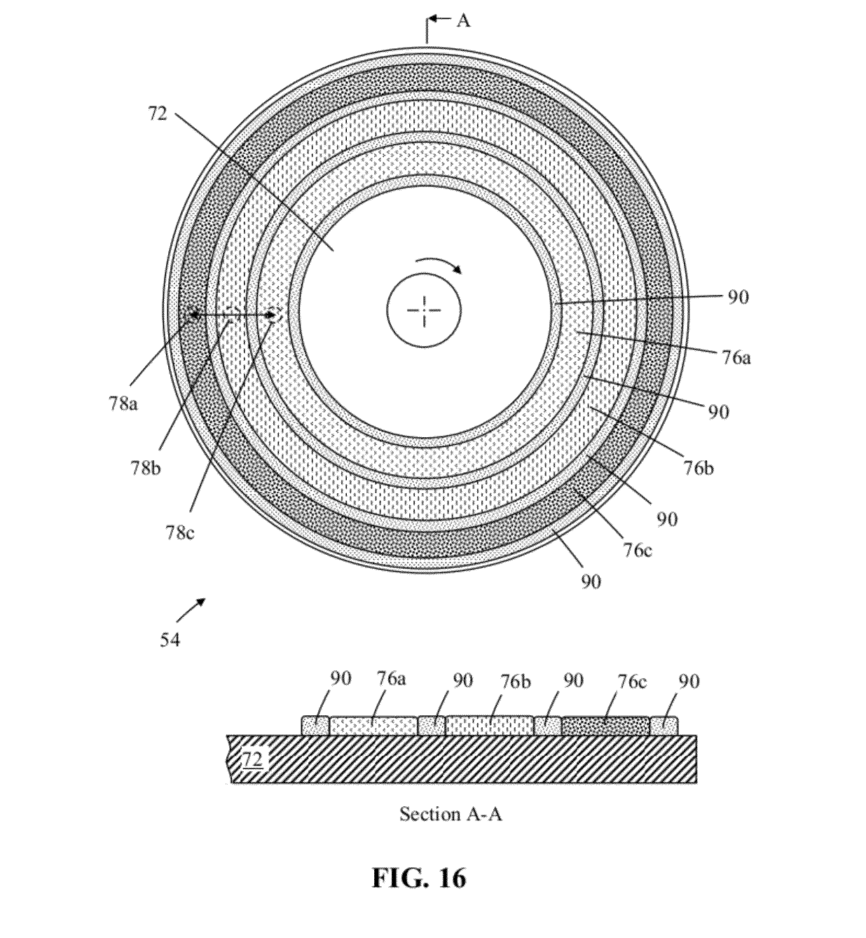

FIG. 16 illustrates an embodiment having multiple strips 76a, 76b, and 76c of material that extends around the entire color wheel 54, where each strip 76a, 76b, and 76c corresponds to a different light emission color. Each of the strip 76a, 76b, and 76c of phosphor material is bordered by reflective material 90 to reduce or eliminate light leakage. In operation, the color wheel is rotated continuously and the color of emitted light is selected by translating a laser spot in a radial direction to be incident on a respective strip of the color wheel. This embodiment is particularly useful to implement entertainment lighting where it is required to generate high intensity light of a selected color.

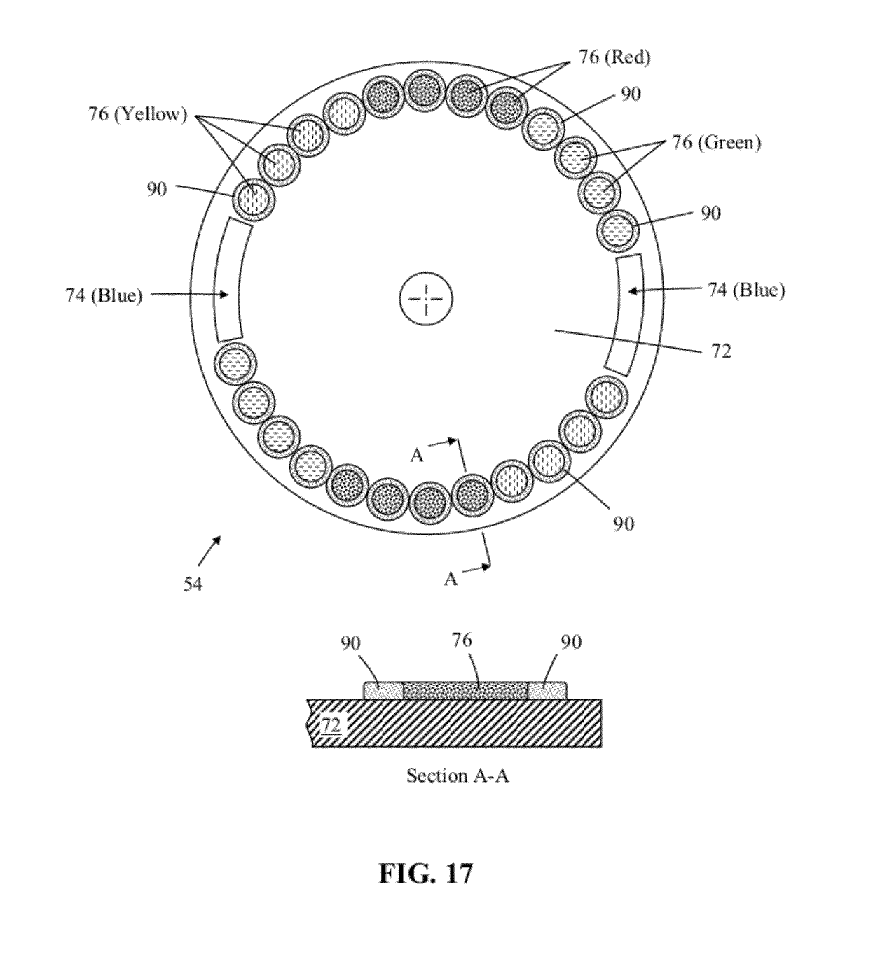

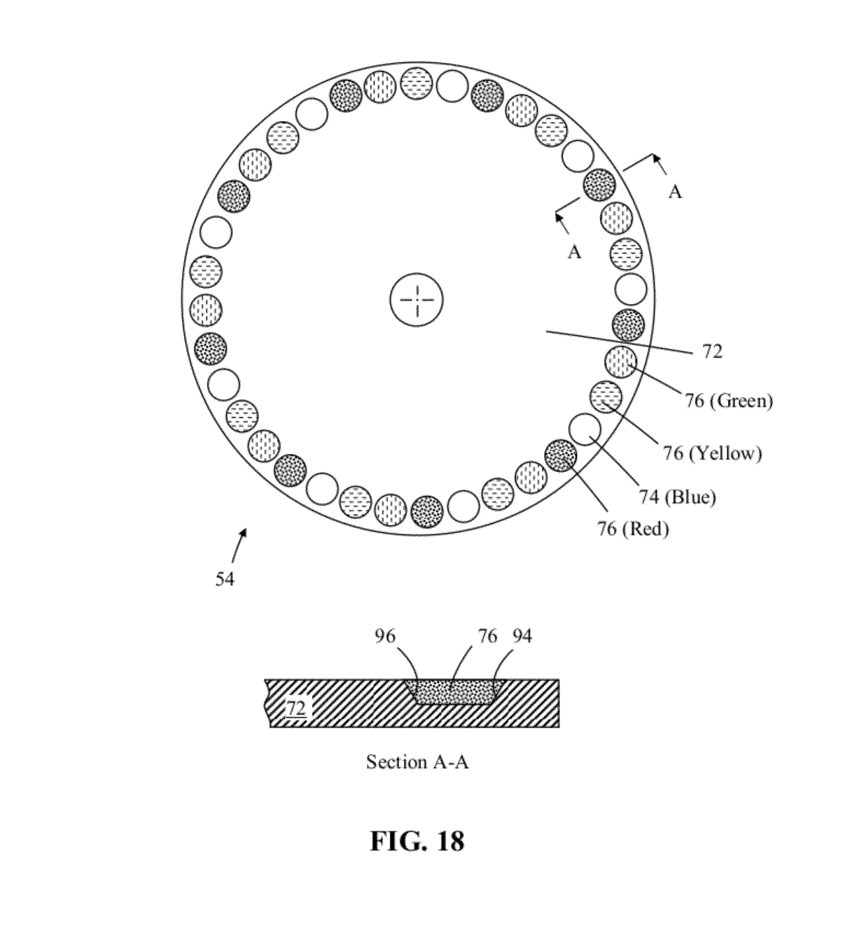

FIG. 17 illustrates yet another embodiment having where the color wheel 54 includes multiple circular regions of phosphor material, where the circular regions are sized to generally conform of the size of the spot for the excitation light. One or more sector shaped apertures (through holes) 74 are also provided to allow the passage of blue light through the color wheel. The circular regions comprise different blue light excitable phosphor materials, such as green, red, and yellow, that are operable to respectively generate green, red and yellow light. A reflective material 90 may be used to border each of the circular regions. The phosphor regions on the color wheel may be organized such that multiple regions of the same color are grouped together on the color wheel, e.g. where each grouping comprises four phosphor regions of the same color. In the alternate embodiment shown in FIG. 18, the color wheel is organized such that the colors of the phosphor regions 76 alternate in color around the color wheel, where a circular aperture 74 of the same size is provided to allow passage of blue light. In this embodiment, the phosphor material is provided within a trench having walls 94 and 96. Either reflective materials 90 or the arrangement having trenches 92 may be employed to border the phosphor regions in FIGS. 17 and 18.

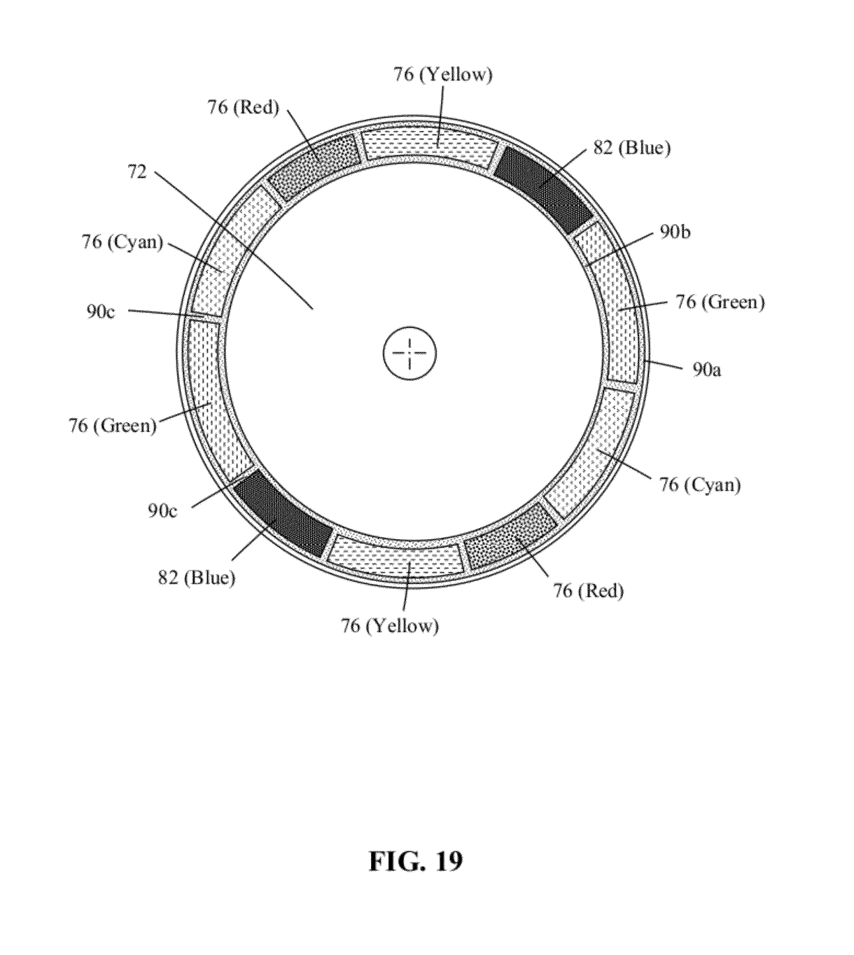

FIG. 19 is a schematic of a color wheel having reflective borders surrounding each of the phosphor materials on the color wheel. In this embodiment, the reflective borders 90a and 90b are provided at the outer and inner borders, respectively, of the phosphor materials similar to the previously described embodiments. In addition, the current embodiment also includes a reflective border 90c provided between adjacent phosphor materials on the color wheel.

It will be appreciated that the number, relative size and/or color of the color wheel sectors can be tailored for a given application. The inventive color wheel can be used in any type of lighting application suitable to include a color wheel. Therefore, while the embodiments of the color wheel has been described above in conjunction with digital projection systems and entertainment lighting, the invention is not limited solely to these applications and can be used in other lighting applications as well.

What is claimed is:

1. A color wheel comprising:
a rotatable disc having a light reflective face and
a region of photoluminescence material deposited on the light reflective face.

2. The color wheel of claim 1, wherein the photoluminescence material is deposited by screen printing.

3. The color wheel of claim 1, wherein in the region of photoluminescence material the quantity of photoluminescence material per unit area is selected from the group consisting of: 10 mg·cm⁻² to 50 mg·cm⁻² and 30 mg·cm⁻² to 35 mg·cm⁻².

4. The color wheel of claim 1, wherein the region of photoluminescence material comprises a substantially uniform thickness layer of thickness selected from the group consisting of: 40 μm to 120 μm and 60 μm to 80 μm.

5. The color wheel of claim 1, wherein the region of photoluminescence material comprises a mixture of particles of the photoluminescence material and a light transmissive binder comprising a curable liquid polymer selected from the group consisting of: a polymer resin, a monomer resin, an acrylic, an epoxy, a silicone and a fluorinated polymer.

6. The color wheel of claim 1, wherein the photoluminescence material is selected from the group consisting of: quantum dots, a phosphor material, a silicate-based phosphor material, a nitride-based phosphor material, a sulfate-based phosphor material, an oxy-nitride-based phosphor material, an oxy-sulfate-based phosphor material, a phosphor material having a Garnet structure, an Yttrium Aluminum Garnet-based YAG-based phosphor materials and combinations thereof.

7. The color wheel of claim 1, wherein the photoluminescence material is excitable by blue light having a wavelength in a range 450 nm to 480 nm and wherein the photoluminescence material is operable to generate light selected from the group consisting of: red, green, yellow, cyan and magenta light.

8. The color wheel of claim 7, wherein the disc further comprises at least one through hole for allowing the periodic passage of blue light.

9. The color wheel of claim 7, and further comprising at least one region of a light scattering material.

10. The color wheel of claim 9, wherein the light scattering material is selected from the group consisting of: titanium dioxide, barium sulfate, magnesium oxide, silicon dioxide, aluminum oxide and a mixture thereof.

11. The color wheel of claim 1, wherein the photoluminescence material is excitable by UV light having a wavelength range 300 nm to 350 nm and wherein the photoluminescence material is operable to generate light selected from the group consisting of: red, green, blue, yellow, cyan and magenta light.

12. The color wheel of claim 1, wherein the light reflective face of the disc has a reflectivity selected from the group consisting of being: at least 0.90, at least 0.95 and at least 0.98.

13. The color wheel of claim 1, wherein the disc is thermally conductive and has a thermal conductivity selected from the group consisting of being: at least 150 W·m⁻¹·K⁻¹ and at least 200 W·m⁻¹·K⁻¹.

14. The color wheel of claim 13, wherein the disc is selected from the group consisting of: aluminum, an alloy of aluminum, an alloy of magnesium, copper and a thermally conductive ceramic.

15. The color wheel of claim 1, and further comprising a light reflective border associated with the region of photoluminescence material.

16. The color wheel of claim 15, wherein the light reflective border comprises a light reflective material.

17. The color wheel of claim 16, in which the reflective material comprises a reflective ink material.

18. The color wheel of claim 15, wherein the reflective border comprises a wall of a trench, and in which the photoluminescence material is deposited within the trench.

19. The color wheel of claim 18, wherein the wall of the trench has a configuration selected from the group consisting of: sloped wall, straight vertical wall, curved convex wall, and curved concave wall.

20. The color wheel of claim 15, wherein the reflective border forms an inner border, outer border, or border between different regions of the photoluminescence materials.

21. The color wheel of claim 1, wherein the photoluminescence material comprises surface features that extend from a surface of the photoluminescence material.

22. The color wheel of claim 1, wherein the region comprises at least two regions of different photoluminescence materials.

23. The color wheel of claim 22, wherein a configuration of the at least two regions of different photoluminescence materials comprise a configuration selected from the group consisting of: concentric strip regions of different photoluminescence materials that extend around the entire color wheel, multiple circular regions with alternating color photoluminescence materials, multiple circular regions with grouped color photoluminescence materials, annular regions of alternating colors of photoluminescence materials, and annular regions of grouped colors of photoluminescence materials.

24. The color wheel of claim 1, wherein the region of the photoluminescence material comprises a single color around the entire color wheel.

25. The color wheel of claim 1, wherein the wheel is incorporated in a light source selected from the group consisting of: a light source for a digital light projection system, a lighting system and an entertainment light.

26. A light source for a digital projection system:
a solid-state light source operable to generate excitation light of a first wavelength; and
a color wheel for generating color modulated light by selectively converting the excitation light to light of different wavelengths, the color wheel comprising a rotatable disc having a light reflective face with at least two regions of different photoluminescence materials that are excitable by excitation light.
